(19) United States
(12) Patent Application Publication
(10) Pub. No.: US 2012/0166271 A1
(43) Pub. Date: Jun. 28, 2012

(54) ARRANGEMENTS FOR FACILITATING e-COMMERCE VIA A TEXT BASED NETWORK

(75) Inventors: Michael R. Wofford, Elkhorn, NE (US); Susan A. Hampel, Omaha, NE (US)

(73) Assignee: Global Transaction Services Group, Inc.

(21) Appl. No.: 13/309,876

(22) Filed: Dec. 2, 2011

Related U.S. Application Data
(60) Provisional application No. 61/426,807, filed on Dec. 23, 2010.

(51) Int. Cl. G06Q 30/02

(52) U.S. Cl. 705/14.44

(57) ABSTRACT

Configurations for electronic commerce are disclosed. In some embodiments, data related to the distribution of advertising content to consumers via at least one media outlet can be acquired and stored. The content can include a message response facilitator useable by a text based message system (TBMS) to provide a selectable link to facilitate a reply path. The selectable link allows a consumer ad-hoc access to a transaction account when the consumer responds to an impression created by the advertising content. The link, when activated, can place the CID in communication with a payment gateway where the communication can include a request for information related to the transaction account, a reply to the request, and a status message from a transaction account authorization entity.

### CROSS-REFERENCE TO PROVISIONAL PATENT APPLICATION

This patent application claims the benefit under 35 U.S.C. §119(e) of U.S. Provisional Patent Application Ser. No. 61/426,807, entitled “System and Method for Advertising, Selling and Tracking Consumer Activity Via a SMS Network,” which was filed on Dec. 23, 2010, the disclosure of which is incorporated herein by reference in its entirety.

### FIELD OF INVENTION

This disclosure generally relates to e-commerce and more particularly to receiving advertising feedback from consumers. More specifically this disclosure relates to the facilitation of an interactive advertising campaign, where a consumer exposed to an advertisement can easily respond to an advertisement and conduct an e-commerce transaction.

### BACKGROUND

Entities advertise and market their product (i.e. goods and services) to consumers in an attempt to persuade prospective consumers (i.e. audience, viewers, readers, listeners, users, etc.) to acquire their advertised product. Different types of media outlets can be utilized to deliver these advertisements (ads), including traditional media outlets such as newspapers, magazines, television, radio, outdoor signage, and direct mail to name a few. More recently, additional media outlets such as websites and mobile communication devices have emerged as media outlets or vehicles to distribute ads to consumers. Currently, it is difficult, if not impossible, for an advertiser to accurately predict exposure to consumers and to predict audience reaction or audience behavior resulting from a particular ad or ad campaign.

Pull advertising or pull marketing refers to efforts of an advertiser to get the ad out to a large group of potential customers in an attempt to expose the ad to customers that are likely interested in the product. Most traditional or offline media outlets as well as online banners ads can be considered pull advertising. Push advertising on the other hand is more tailored or focused and generally attempts to push or lure potential customers from a known or targeted pool of consumers into purchasing a product. In pull type advertising, the advertiser might have data or know something about the targeted audience. For example, the target audience might be past customers, persons who have expressed interest in the product, or persons who have a relationship with the advertiser or are in some other way known to the advertiser. Examples of pull advertising campaigns are campaigns where communications are sent to a known address of a user such as an email address or a physical address.

Traditionally, a consumer will be exposed to an advertisement and even if the consumer wants the advertised product, considerable time will pass before the consumer can physically react to, or respond to the advertisement. For example, a consumer seeing a billboard, hearing a radio commercial, or seeing a television commercial must find time to visit a retail location in person, call a retailer, mail in an order form, or go to a specified website to initiate and obtain the product. The methods that allow for a consumer to make a timely, in the moment response to an impressionable advertisement (ad) when they desire to purchase the advertised product are less than perfect. In addition to this inefficiency, traditional ad-purchase cycles require a retailer to have and maintain expensive real estate, storefronts, and/ or staff.

### SUMMARY OF THE INVENTION

Disclosed herein are configurations for conducting e-commerce. E-commerce can include the online process of developing, marketing, selling, delivering, servicing, and paying for products and services over electronic systems such as the :Internet and other computer networks, although it may encompass a wider range of technologies such as e-mail, mobile devices, and telephones as well. The configurations can include storing data related to the distribution of advertising content to consumers via at least one media outlet. The content can have a message response facilitator (i.e. telephone number, keyword or short code) useable by a text based message system (TBMS) to provide a reply path such that a consumer, via a consumer interface device (CID), can respond to an impression created by the advertising content and can request access to a transaction account. The consumer can request access to a transaction account to facilitate e-commerce for the advertised product. Some configurations can monitor a response communication from the CID via the reply path. The disclosed embodiments can facilitate the transmission of a selectable link to the CID and the selectable link when activated can place the CID in communication with a front-end commerce application, and ultimately the transaction account via a transaction account authentication entity. The selectable link could be a Universal Resource Locator (URL) accessible via the Internet Protocol format.

In some embodiments, the method can include storing data related to the distribution of ad content to consumer via at least one media outlet, the content having a message response facilitator useable by a text based message system (TBMS), the ad/marketing text campaign application to provide a reply path such that a consumer via a CID responds to an impression created by the ad content, and automatically requests access to a transaction account. The disclosed configurations can monitor a response communication from the CID via the reply path and can facilitate the transmission of a selectable link to the CID. When the link is activated, it automatically places the CID in communication with a front-end commerce application using a seamless communication Internet Protocol format path such as those used by 4G and 5G telecommunications networks. The e-commerce front-end application can place the CID in communication with a transaction account authentication entity. The communication can include a request for information related to a transaction account associated with the CID.

The disclosed embodiments can facilitate a reply to the request and an authorization status message be sent from a transaction account authorization entity. In some embodiments, a consumer, in response to a targeted ad, is presented with a reply path to initiate and complete an e-commerce transaction to acquire the advertised product utilizing their mobile phone. The mobile phone can complete the transaction without having to download or locally execute software from an entity conducting a financial transaction such as a gateway or an authorizer.

Another embodiment provides a machine-accessible medium or computer useable medium containing instructions effective, when executing in a data processing system, to cause the system to perform a series of operations where consumers, exposed to an advertisement, can utilize a secure TBMS communication link via a consumer interface device to respond to a reply path provided in the advertisement to conduct an e-commerce transaction to acquire the product. The disclosed system can operate over commonly available telecommunications networks and can offer a consumer the opportunity to immediately and conveniently respond to a visual or audio ad and conduct an e-commerce transaction immediately after seeing the ad in near real time from any location where telecommunication service is available.

### BRIEF DESCRIPTION OF THE DRAWINGS

Advantages of the disclosed embodiments will become apparent upon reading the following detailed description and upon reference to the accompanying drawings in which like references may indicate similar elements:

FIG. 1 depicts a monetization of a pull ad/marketing message embodiment;

FIG. 2 is a flow diagram that illustrates a pull ad/marketing message monetization process;

FIG. 3 depicts a monetization of a push ad/marketing text campaign message embodiment;

FIG. 4 illustrates a subscriber opt-in or registration to a push ad/marketing text campaign embodiment; and

FIG. 5 is a flow diagram that illustrates a push ad/marketing text campaign message monetization process.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. In the following description, like reference characters designate like or corresponding parts throughout the figures. Additionally, in the following description, it is understood that terms such as “first,” “second,” and the “like” are words of convenience and are not to be construed as limiting terms.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein,

Currently, there is no effective and efficient way to accurately monitor, quantity, relate, and estimate the success or failure of a particular campaign or determine how many people were targeted or were exposed to an ad, and how many people who, as a result of the exposure, actually responded to and/or initiated and/or completed an e-commerce transaction or took some other action. Currently adverting metrics require many assumptions and calculations and are merely estimates provided by many variables. More specifically, audience reaction and behavior in response to an ad, or ad campaign, depends on many factors such as the content of the ad, the type of media outlet utilized, the audience the content reaches, the duration and time of day the ad runs, the type of targeting the campaign uses, and data that relates these variables to a success metric.

There has been a proliferation of the consumer communication devices, for example, mobile phone penetration in the United States that has surpassed cable television, web access, and home PCs in numbers. Wireless devices are becoming ubiquitous as today many people own PDAs, tablets or laptops or other wireless device. In addition, most of these people carry their devices wherever they go. The ad-hoc convenience provided by the teachings of the present invention will allow mobile payments to rapidly become an accepted mainstream method for the public to control transaction accounts or financial accounts.

Advertisers and transaction account authorizing entities operate as two separate and distinct silos. The present invention facilitates mobile advertising with transaction account management via customer interface device such as a mobile phone. The teachings herein provide efficient, effective, and robust configurations for directly monetizing an ad by offering an immediate connection for a consumer to connect with and modify a transaction account.

In another silo, methods used by product providers (goods and services) to advertise and sell their products are changing with the proliferation of communication devices. Penetration and rate of penetration of the mobile phones in the United States has surpassed cable television, web access, and personal computers (PCs) in terms of users. As a result, product providers continue to have new ways to reach prospective customers ads. The disclosed embodiments provide a simple seamless way to affect commerce via communication with these devices that can be reached by the advertisers.

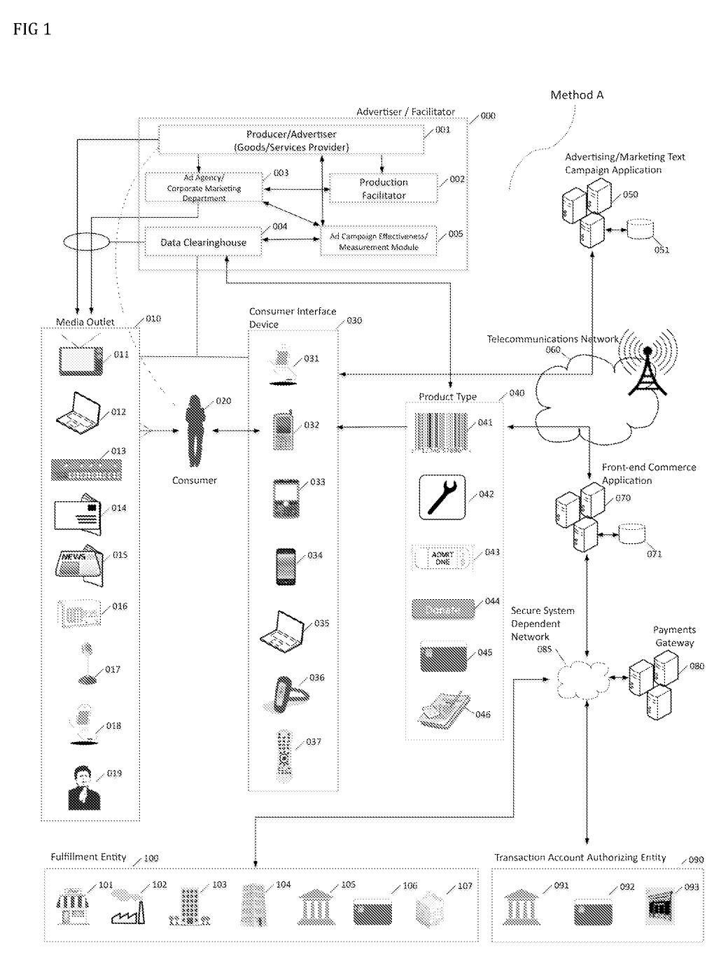

Referring to FIG. 1, the system can include an advertiser/facilitator 000, media outlet 010, consumer 020, consumer interface device (CID) 030, product type 040, ad/marketing text campaign application 050, telecommunications network 060, front-end commerce application (FECA) 070, payments gateway 080, secure system dependent network (SSDN) 085, transaction account authorizing entity (TAAE) 090, and fulfillment entity 100.

In some embodiments, configurations for e-commerce are disclosed. In some embodiments, data related to the distribution of ad content to consumer 020, via at least one media outlet, can be acquired and stored. The content can include a message response facilitator (MRF) such as a specific telephone number or a short code for use by the consumer 020 to reply and indicate interest in the advertised product. The message response facilitator useable by a text based message system (TBMS) can provide a reply path such that a consumer 020, via a CID 030, can select the reply path to conduct an e-commerce transaction to acquire the product. The disclosed configuration can monitor a response communication from the CID 030 and facilitate transmission of a selectable link to the CID 030.

The reply path when activated can place the CID 030 in communication with a FECA 070 where the communication can include the e-commerce transaction request consisting of information such as the purchase quantity, amount, delivery, etc., and the consumer's transaction account details, and a reply to the request consisting of information such as the transaction account authorization status from a TAAE 090 and/or fulfillment entity 100. A consumer 020 can access a transaction account without downloading a proprietary financial transaction application and executing such an application on the CID 030. Consumer 020 activities performed in response to the impression made by the ad content can be stored, analyzed, and used to improve the effectiveness of future ad campaigns.

In some embodiments, ad content with a textual component with a reply path is distributed via an ad/marketing text campaign system 050 to a consumer 020. The consumer 020, via a CID 030, can select the reply path to conduct an e-commerce transaction to acquire the advertised product. The reply path when activated can place the CID 030 in communication with a front-end commerce application 070 where the communication can include the e-commerce transaction request consisting of information such as the purchase quantity, amount, delivery, etc., and the consumer's transaction account details, and a reply to the request information consisting of information such as the transaction account authorization status from a TAAE 090/or fulfillment entity 100. A consumer 020 can access a transaction account without downloading a proprietary financial transaction application and executing such an application on the CID 030. Consumer 020 activities performed in response to the impression made by the ad content can be stored, analyzed, and used to improve the effectiveness of future ad campaigns.

In sonic embodiments, the system can identify media outlets associated with the ad content and acquire and store consumer 020 activity data based on the consumer's 020 response to the ad content. The consumer 020 activity data can be organized and analyzed to create metadata about the system and consumer 020 activity. In some embodiments, the response code is a simple short code Or keyword that is unique to a specific entity and can be tailored to the consumer's 020 interface device. In addition, data associated with the e-commerce transaction can be sent to a fulfillment entity associated with a producer/provider associated with the advertisement. Authorizing against a consumer's transaction account can include one of an approval or a denial to the financial transaction request and a reply to a consumer 020 based on the approval or denial. In some embodiments, authorization can include compiling logistical information associated with the advertisement and the e-commerce transaction request. Logistical information such as sale, packaging shipping or delivery information can be tracked and can trigger automated event statuses to be sent via a text message to the consumer 020.

A media outlet 010 can be any type of entity that places content in front of prospective consumers 020 such as television, a computer, signage, printed material, a radio broadcast, a wireless mobile communication device, or even an advocate to name a few. Publishing can be defined as the process of production and dissemination of literature or information printed or electronic including the activity of making information available to the general public through any media outlet.

Pull type ad methods can include an advertiser/facilitator 000 (goods and service providers), media outlets 010, a consumer 020, a CID 030, a product type 040, an ad/marketing text campaign application 050, a FECA 070, a payments gateway 080, a TAAE 090, and a fulfillment entity 100 or a product producer/provider to name a few.

In a specific example, the advertiser/facilitator 000 can be a jeweler, media outlet 010 can be a television, the product type 040 can be a good such as a diamond ring, the ad/marketing text campaign application 050 can be e-TXT, the FECA 070 can be Extreme Mobility, the payments gateway 080 can be Visa, the TAAE 090 can be a financial institution 091 such as a bank that is responsible for the issuance and administration of a credit card account, and the fulfillment entity 100 can be a jewelry importer, manufacturer, warehouse or distributor.

The ad/marketing text campaign application 050, FECA 070, payments gateway 080, TAAE 090, and fulfillment entity 100 can: each reside on programmable and/or processing devices such as one or more servers; receive data and control signals; store and manipulate data; and provide output in a useful format. The CID 030 and the servers can be in communication with one another over a secure network. The products offered advertiser/facilitator 000 can be advertised via various types of media outlets 010 such as television 011; web-based postings 012; fixed location public displays 013; printed marketing materials 014; publications such as newspapers or magazines 015; radio broadcasts 016; public announcements 017; wireless device-based communications 018; and advocates 019 such as spokespersons and/or sales people.

The consumer 020 can be exposed to visual or audible content and can utilize a CID 030 to respond to the content. The CID 030 is a device that allows the consumer 020 to initiate communication with an ad/marketing text campaign application 050 via a text message to a specific telephone number or to a short code to indicate interest in the advertised product. The ad/marketing text campaign application 050 receives the text message from the consumer 020 then transmits a text message with reply path such that a consumer 020, via a CID 030, can select the reply path to conduct an e-commerce transaction to acquire the product. The CID 030 is capable of allowing the consumer 020 to respond to text content over a secure connection to the FECA 070, transmit an e-commerce transaction request, and receive a response to the e-commerce transaction request from the FECA 070. The CID 030 can then display the response to the consumer 020. The CID 030 could include any device capable of being mobile and/or capable of communicating with another device with or without a wired connection.

In operation, a consumer 020 can be exposed to an advertisement for a number of different types of products 040 including, but not limited to, soft or durable goods 041, services 042, event tickets 043, donations to non-profit organizations, charities, political campaigns, organizations or causes 044, additional value to prepaid cards 045, and payment of bills or invoices 046. The telecommunications network 060 allows the OD 030 to communicate to a wired communication device such as the FECA 070, the telecommunications network 060 can translate textual and other communication protocols into the desired format for secure network communications.

The efficiency of the disclosed embodiments allow for an advertiser to serve an ad to a first time customer and receive a payment for a product from the first time customer without a lengthy exchange of information such as a download, local execution of an application from a financial institution such as a payment gateway or a transaction account authorization entity, and tediously entering data. The disclosed configurations provide a last, ad-hoc, and with “one touch” or “few touches” input from a consumer can put the consumer in touch with his transaction account facilitator. Such a method allows Dora smooth and pleasurable consumer experience for a customer who wants to initiate and complete an e-commerce transaction.

A transaction account can be considered a debit, credit or prepaid account from which a consumer 020 can make debits against and/or transfers funds to third parties. Demand-deposit accounts, negotiable order of withdrawal (NOW) accounts, automatic transfer service (ATS) accounts, credit union share draft accounts, brokerage accounts, insurance accounts, credit card accounts or prepaid accounts are examples of transaction accounts at banks, other depository institutions or third parties. Payments gateways 080 are linking entities that have networks that communicate with acquirers of financial transactions and issuers of payment vehicles. These networks facilitate the communication among network participant for the purpose of exchanging financial transactions. Visa, MasterCard, Interac, NYCE, and Star are examples of payment gateways in North America.

The TAAE 090 can grant or deny access to the consumer's transaction account. The TAAE 090 can provide authorization in a two-step process. The first stage can be authentication, which ensures that a consumer 020 is who he or she claims to be and the second stage can be authorization, which allows the consumer 020 access to the transaction account funds based on the consumers 020 identity. The FECA 070 can be responsible for initiating a financial transaction request via payments gateway 080 to the TAAE 090 to request and obtain approval for a financial transaction request. The FECA 070 can also transmit confirmation information such as a sale, packaging shipping and/or delivery information, or a record or receipt of the completed financial transaction to the fulfillment entity 100 to complete the transaction. The FECA 070 can include a database 071 that can store the account information of the consumer 020.

The payments gateway 080 can provide an interface to and can communicate with a TAAE 090 to facilitate funding for or authorization of a financial transaction request. The TAAE 090 could be a financial institution 091 where the consumer 020 has an assigned and approved transaction account such as a credit card account or a bank account, a prepaid service provider 092, or a goods or service provider 093 where the consumer 020 has an assigned and approved financial account such as a credit or prepaid account. It can be appreciated that the account held by TAAE 090 includes any funding or financial account from which the consumer 020 can control. The TAAE 090 could manage consumer's 020 bank accounts, credit card accounts, prepaid accounts, brokerage accounts, insurance accounts, mobile wallet accounts, or any credit or debit account. Payments gateway 080 can communicate with the TAAE 090 over a secure system-dependent network 085. In some embodiments, a financial transaction authorization via a TAAE 090 can be completed in near real-time, or with minimal delayed such as in the case where the payments gateway is the Automated Clearing House (ACH) and the authorizing TAAE 090 is a financial institution 091 housing the funding or financial account. The disclosed system can pre-verify the consumer's 020 identity as the signatory, owner, or controller of the transaction account based on the consumer's mobile device identifier to seamlessly, easily, and automatically facilitate transaction approval by the system.

One purpose of fulfillment entities 100 is to complete (the loop on) the non-financial aspects of the e-commerce transaction processing such as packaging, shipping, delivery, and receipt. verification for the contribution, good, and/or service. The fulfillment entity 100 could be a retailer 101, manufacturer or distributor 102, a creditor 103, a utility company 104, a financial institution 105, a prepaid service provider 106, or a fulfillment house 107. Once the financial transaction has been made and affirmed through the payments gateway 080, the records or database of the fulfillment entity 100 can be updated accordingly. Fulfillment of an e-commerce transaction can vary based on what product or service was acquired, what the specified delivery conditions are, and other parameters as known by or determined by the fulfillment entities 100 such as delivery tracking via the Internet.

The FECA 070 can communicate with the fulfillment entities 100 over any type of network such as a private communication network, a public network, or a secure system-dependent network 085 in order to initiate fulfillment of the e-commerce transaction request or for providing assistance with the deliverables. It can be appreciated that an advertiser/producer 001, such as a producer of or distributor of a product, who advertises and is a facilitator of commerce, typically desires to be able to evaluate the effectiveness of their ad campaign. Heretofore, with media outlets 010 such as radio and television, there was no effective and efficient way to accurately determine how many potential customers 020 who were targeted and actually received an advertisement, and how many people who, as a result of being exposed to the advertisement, actually made an e-commerce transaction or took some other action based on exposure to the advertisement. Likewise, heretofore, it has been difficult if not impossible to accurately measure the effectiveness of customer 020 or client loyalty programs, couponing campaigns, and other promotional efforts. Some embodiments of the present disclosure provide an automated system for accurately determining audience behavior or reaction and ultimately providing an effectiveness metric for an ad campaign back to the advertiser so that the advertiser can determine not only the cost per exposure but also the cost per sale from a particular ad campaign. Thus, different types of ad campaigns (methods, etc.) on a particular product, type of product, and group of products can be rated as to their effectiveness. It can be appreciated that an ad campaign for a particular group of products via a particular timing and particular media outlet may be very successful, while nearly the same campaign parameters when used for a different group of products may fail miserably.

Thus, the disclosed ad campaign effectiveness/measurement module 005 can use effectiveness data to suggest campaign strategies and can assist an advertiser in implementing an ad campaign based on the product to be marketed. In some embodiments, if an advertiser provides parameters regarding a proposed ad campaign, the system can accurately forecast the success of the proposed campaign or the cost per exposure or cost per sale for a particular ad campaign. The disclosed system can collect data based on consumer feedback from specific advertisements and the success of an ad campaign can be stored, analyzed, and utilized for future campaigns. Such data can enable an advertiser to more accurately determine or predict audience behavior or audience reaction based on a proposed advertisement or ad campaign. The data also allows a prospective advertiser to predict targeted audience reactions for a proposed ad campaign prior to the creation and delivery of the ad or marketing message.

For example, the disclosed system might provide data that suggests changing delivery parameters such as the type of media outlet, ad content time of day or a combination thereof to make the ad campaign more effective. Such suggestions can be made based on past successes metrics or circumstances that can predict better ad campaigning based on past data. In some embodiments, the system can be set up as a pull type ad campaign where an advertiser via the system provides content to a consumer and the consumer via their CID 30 can respond to an ad via a reply path provided by a text based communication system. Such a connection allows the consumer to conduct an e-commerce transaction and possibly acquire the product. The disclosed system can operate in a push or pull format.

Thus, for a propose ad campaign, the disclosed system can provide an accurate estimate for a business's ad return on investment (ROI) to better assist an advertiser in planning an ad campaign. The disclosed system can also provide suggestions or proposals to an advertiser based on an advertiser's needs or based on a proposed ad campaign from an advertiser. For example, based on the desired target audience or the products to be advertised and sold, the disclosed system might suggest the best media outlet and ad timing for a particular ad campaign. Such suggestions can be based on historical data such as the success of previous ad campaign with similar material factors. The disclosed system can provide a cost/benefit or a projected effectiveness or ROI rating for a proposed ad campaign to the advertiser prior to launch of the campaign and the advertiser can use this prediction model to make changes before a final launch decision. Thus, the disclosed system can utilize and analyze the ad campaign parameters and compare them to campaign parameters from past campaigns and provide the prospective advertiser with projected success metrics such as audience penetration for various consumer 020 classifications. The system can provide estimated metrics and suggestions to a prospective advertiser regarding how to maximize the return on their ad dollar.

Continuing with FIG 1, an advertiser/producer 001, a production facilitator 002, an ad agency/corporate marketing department 003, a data clearinghouse 004, and an ad campaign effectiveness/measurement module 005 can interact to provide feedback regarding the ad campaign before the ad campaign is started thereby providing increased sales or find raising. Advertisers often want to target a particular cross section of the public to improve ad effectiveness and thus, get the most return from their ad expenditure. There are different levels of targeting customers or an audience. For example, an advertiser/producer 001 can choose to target potential customers based on geographic, demographic, and behavior characteristics to name a few. Depending on the product, geographic targeting is a fairly coarse targeting method and behavioral targeting provides much finer granularity of targeting.

It can be appreciated that often the finer the granularity, the more expensive the cost of the ad per exposure. Behavioral targeting can be performed when the advertiser not only knows something about the audience's geographic and demographic characteristics, but also about the audience's behavioral characteristics. Thus, targeted ads can be sent to an individual consumer 020 based on geographic, demographic, and behavioral data. For example, an ad for a new Ferrari dealership in Omaha, Nebr. can be sent to a wealthy executive in the Omaha area who drives a newer Porsche. For micro targeting, audience data can be purchased from an agency or can be obtained and can be data related to the monitoring of user movement acquired by the CID 030. The disclosed system and method can also provide customer data to third parties.

Initially, an advertiser/producer 001 can create the ad campaign, which will typically include a budget and target audience. The producer will often consult an ad agency/corporate marketing department 003 for advice regarding a campaign plan to determine how to maximize exposure to desirable audience targets for a given budget. The advertiser/producer 001 or the ad agency/corporate marketing department 003 could hire or consult with a production facilitator 002 (often part of the media outlets 010) to produce and publish the advertisement. After an advertisement is published or run, an advertiser/producer 001 can get data regarding how, when, and if the ad ran and what audience was exposed to the advertisement. This data can be compared to the original ad campaign plan to see if the advertiser/producer's 001 ad(s) got the exposure that they paid for or they desired. Adjustments to the cost and/or the mechanics of the campaign can then be made according to actual exposure results/data instead of projected results. In some embodiments, a data clearinghouse 004 can monitor multiple audience interactions with electronic CID 030 and, for example, can acquire audience data such as behavioral data based when a consumer 020 such as an audience member performs a transaction on an electronic CID 030 based on exposure to an ad provided by media outlets 010. Systems such as the FECA 070 and/or the fulfillment entities 100 can also provide consumer 020 activity or e-commerce transaction data to the data clearinghouse 004.

Although data clearinghouse 004 and other parts of the system are shown as if they are placed at a single location, in some embodiments, data clearinghouse 004 and other system components can be ubiquitous and can have and operate in many locations simultaneously where there is data to be acquired and mined. The ad campaign effectiveness/measurement module 005 can accept data such as which ads ran, if the ads ran as scheduled, when they ran, how much exposure the ad received, how much money was spent, per target, what media or combination of media was used, how many consumer 020 reactions the ad created, how many purchases inquires, responses the ad created, what percentage of the audience exhibited what particular responses, etc. Thus, the ad campaign effectiveness/measurement module 005 can set metrics by which future campaigns can be compared or measured. In some embodiments, the system allows a media outlet 010 to charge a premium price per ad because of the data that can be provided that shows a success rate of the advertisement. In some embodiments, the service providers can set up a pay for performance system where the advertiser/producer 001 only pays for ads that result in a purchase or some type of transaction.

In accordance with another important aspect of the present invention, after an e-commerce transaction is completed based on an ad/marketing campaign, the advertiser/facilitator 000 can communicate with the consumer 020 using this system. This communication can include any information related to the e-commerce transaction (i.e., order confirmation, sales receipt, shipping info, addressing info, delivery method, projected delivery date, return info, etc.). Any or all of the functions of the advertiser/facilitator 000, the ad/marketing text campaign application 050, the FECA 070, the payments gateway 080, the TAAE 090, and fulfillment entity 100 may reside on one or more common servers.

In some embodiments, the system can be utilized as a fan appreciation and awards system using a fan card to facilitate the system. In these embodiments, sports organizations can issue cards to the fans. As the fans use their cards, they earn loyalty points with the organization. The organization can push out TBMS ad messages with reply paths to have fans “top-up” their fan cards or purchase franchise items via the disclosed system. The organizations can also push out incentives for sponsor related products. In some embodiments, a credit/debit card system can be incorporated such as Visa, MasterCard, American Express or a gift/loyalty card provider such as Opticard for authorization and tracking financial transactions. This allows a fan or loyally member to use the same card at games and events via concession stands, kiosks, merchandise stores, etc., to cut down on cash transactions and employee theft.

Media outlets 010 could be a television 011 where ad or marketing messages can be displayed or articulated on the television 011 using different types of formats including, but not limited to, commercials, paid promotional programming, and shopping based channels or networks. In some embodiments, media outlets 010 could be embodied by a web-based content 012. Web-based ad or marketing messages may be displayed or articulated on a variety of sources including, but not limited to, web ads, websites, and social network postings, and could use selectable links. Web-based content may be viewed or heard on a number of different devices including, but not limited to, personal computers, laptops, net books, PDAs, and smart phones.

Media outlets 010 could also be embodied as a static or dynamic public display 013. Ad or marketing messages could be displayed or articulated on a variety of viewable sources including, but not limited to, static or dynamic billboards, scoreboards, movie trailers, displays or posters. In some embodiments, media outlets 010 could consist of printed marketing material 014. Ad or marketing messages may be read from a variety of marketing material sources including, but not limited to, direct mail, postcards, letters, brochures, pamphlets, and flyers,

Media outlets 010 could also consist of publications such as newspapers or magazines 015. Ad or marketing messages may be read from a variety of periodical sources including, but not limited to, newspapers, magazines, newsletters, and circulars. In some embodiments, media outlets 010 could consist of a radio station 016. Ad or marketing messages may be articulated on a radio during a variety of broadcasts including, but not limited to, commercials and paid promotional programming.

Media outlets 010 could also consist of a public announcement 017. Ad or marketing messages may be articulated during a public broadcasts at various events including, but not limited to, sporting, entertainment, political, promotional, fundraising, and charitable events. In yet additional embodiments, media outlets 010 could consist of a wireless device-based communication 018 where ads could be displayed or articulated using a variety of sources and formats including, but not limited to, text messages, micro-blogging messages, web ads, websites, and social network postings. Wireless devices 018 could include, but not limited to, devices such as laptops, notebooks, tablet computers, PDAs, and smart phones. Media outlets 010 could also consist of an advocate, salesman, speaker, representative or spokespersons 019 where the person representing the product or fundraiser can articulate the message.

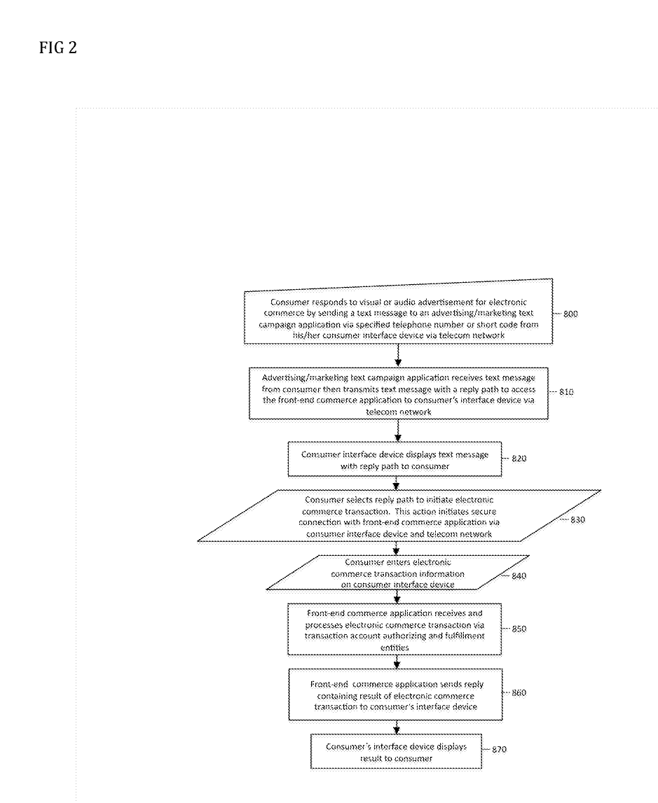

Referring to FIG. 2, a flow diagram is illustrated that provides a pull ad/marketing message monetization process. As the process begins at block 800, the consumer 020 being exposed to an advertisement can respond to the visual or audio content that suggests an e-commerce transaction by sending a text message to a specified telephone number or by entering a short code from his/her CID 030. As illustrated by block 810, ad/marketing text campaign 050 can receive the text message from the consumer 020 and transmits a text message with a reply path to access the FECA 070 to the CID 030 via the telecommunications network 060. The CID 030 can display the text message to the consumer 020 as illustrated by block 820. In some embodiments, the text message has an embedded hyperlink that when activated can seamlessly activate a browser on the CID 030 and retrieve an interface page and display the page thereby “taking” the consumer 020 to a predetermined site. Thus, the disclosed system can have a reference within the text that when selected by a consumer 020 automatically redirects the consumer 020 to a page where an e-commerce transaction can be performed. With one or more touches of the keypad, the consumer 020 can directly link to a site where an e-commerce transaction can be completed. The consumer 020's request to perform an e-commerce transaction is in response to a text based advertisement sent to the consumer 020 can redirect the consumer 020 to the FECA 070.

Thus, upon a consumer's textual input or selection of a link provided, as illustrated in block 830, the consumer 020 can be seamlessly connected via a secure connection with the FECA. 070 from his/her CID 030 via the telecommunications network 060. As illustrated by block 840, the consumer 020 is prompted for and enters transaction data such as the number of items, delivery option, delivery address, and various options such as color, size, or date of event, and is prompted for and enters payment information to identify and access a funding or financial account on his/her CID 030. It can be appreciated that payment information to identify, access, and modify or debit a finding or financial account may include, but is not limited to, a user ID, a pass code, a card number, a security code, card verification code, a bank routing number, an account number, an identification name, a password, an access code, a PIN, security questions, or any combination thereof.

In addition, the FECA 070 can verify that the consumer 020 response received is from a particular advertisement sent to the same phone number that the advertisement was sent. In addition, the FECA 070, payment gateway 080 or the TAAE 090 can then authenticate that the TBMS message is a response from a known advertisement and originated from a known phone number and that the phone owner is authorized to make such a transaction via records such as bank records. In some embodiments, the TAAE 090 can check and see what telephone number or consumer 020 device identifier that the consumer 020 has on file with their financial account, or a number that the consumer 020 has conducted transactions with in the past and possibly collaborate financial data or subscriber data bills payment records, etc., of a carrier such as AT&T, T-Mobile, etc. Based on these and other verification/authentication methods/data, the TAAE 090 can authorize the financial transaction and transfer funds or points amongst accounts and send records of such transactions to other components such as fulfillment entity 100 and the advertiser/producer 001 so they can take action or calculate a commission, if applicable.

As illustrated by block 840 and in some embodiments, if the consumer 020 has previously utilized the FECA 070, payment information may already be stored based on unique wireless communication device identifier and may not be required to be entered for sequent financial transactions. The consumer 020 may be required, however, to reenter a secret code such as PIN, password, CVV/CVC, etc., to verify access to the funding or financial account. If the consumer 020 has not utilized the FECA 070 or desires to use a different finding or financial account than already stored, then new account or payment information must be entered. The system contemplates a method that allows multiple funding or financial accounts to be stored for use for subsequent financial transactions. By closing the communication loop, or verifying that the consumer 020 requesting an e-commerce transaction was actually sent the ad, this can avoid a situation where a loyal consumer 020 is provided with a reduced or preferential price and this customer forwards the ad to others who when trying to purchase would be denied because the loop cannot be closed. The advertiser based on their preference could set this anti-theft system.

As illustrated by block 850, the FECA 070 can receive the e-commerce transaction request from the CID 030. In response, the FECA 070 can process the commerce transaction in conjunction with a TAAE 090 and a fulfillment entity 100. As illustrated by block 860, the FECA 070 can send a reply to the CID 030 that contains a result of an e-commerce transaction and the CID 030, as illustrated by block 870, can display the results to the consumer 020. In the event that the financial or fulfillment portions of the request are not approved, the FECA 070 can reject the e-commerce transaction and send such a message to the CID 030, to alert the consumer 020 as illustrated by blocks 860 and 870.

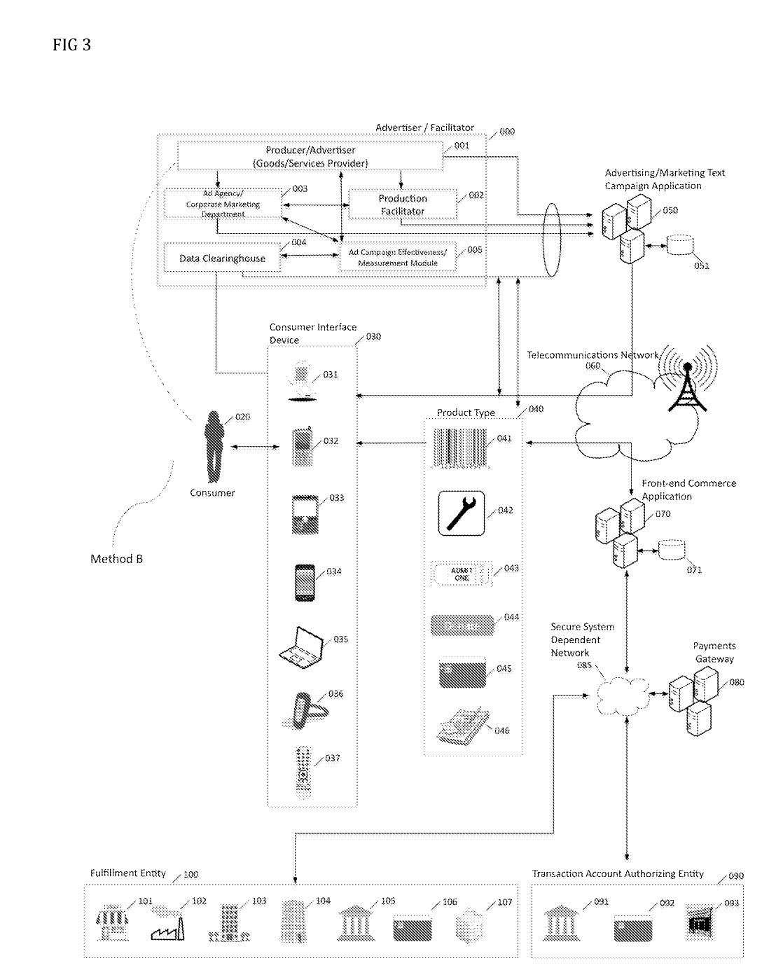

Another method embodies a push type ad/marketing campaign wherein consumers 020 respond to text based advertisements sent to their CID 030(s) related to an e-commerce transaction such as a donation or purchase of a product. FIG. 3 through FIG. 5 illustrates processes and flows for a push type ad/marketing messages. With reference to FIG. 3, a text based push type ad/marketing embodiment is disclosed in accordance with the present disclosure which can include an advertiser/facilitator 000, an ad/marketing text campaign application 050, a consumer 020, a CID 030, a FECA 070, a payments gateway 080, a TAAE 090, and a fulfillment entity 100. The advertiser/producer 001 could be a football franchise, the TAAE 090 could be a prepaid card provider 092 responsible for issuance and administration of a prepaid fan card account, and the product provider/fulfillment entity 100 could be a sporting event ticket broker. The ad/marketing text campaign application 050, FECA 070, a payments gateway 080, TAAE 090, and fulfillment entity 100 can each reside on devices capable of processing information and can be programmable devices such as servers that receive input, store, and manipulate data, and provide output in a useful format. The CID 030 and such servers can be in communication with one another.

One purpose of the ad/marketing text campaign application 050 is to generate at least one ad/marketing text message with an embedded reply path or hyperlink to facilitate a seamless e-commerce transaction based on the message to generate a distribution list including at least one consumer 020 and to initiate transmission of at least one text message. Text to buy services such as e-TXT is typically subscriber-based services where the subscriber provides a campaign distribution list and a marketing or ad message to be transmitted to the recipients. A database 051 can store the subscriber and campaign information.

The CID 030 communicates with the ad/marketing text campaign application 050 via a telecommunications network 060. The telecommunications network 060 is a collection of terminals (starting and stopping points in any telecommunication network environment), links, and nodes that connect together to enable telecommunication between users of the terminals. Examples of a telecommunication network include computer networks, the Internet, the telephone network, cellular networks, the global Telex network, and the aeronautical AGARS network.

An embedded hyperlink can be sent to and the consumer 020 can receive the text messages and can click on the embedded hyperlink to initiate an e-commerce transaction request utilizing a CID 030. Thus, the CID 030 can be a device that allows the consumer 020 to initiate e-commerce transaction requests. The CID 030 is capable of allowing the consumer 020 to respond to the ad/marketing message, set up the connection to the FECA 070, transmit the e-commerce transaction request, receive the e-commerce transaction request response from the FECA 070, and display the response to the consumer 020. Examples of CID 030 include a mobile cellular phone 031; a wireless enabled personal digital assistant (PDA) 032; a mobile cellular capable personal digital assistant such as a smart-phone 033; a portable media player with a mobile communication platform 034; desktops, laptops, net books, and tablets 035; wireless headsets such as Bluetooth devices 036; and television remote control devices 037. The telecommunications network 060 allows the CID 030 to communicate to a wired communication device such as the FECA 070, the telecommunications network 060 can translate textual and other communication protocols into the desired format for secure network communications.

FECA 070 can be responsible for initiating a financial transaction request via payments gateway 080 to the TAAE 090 to request and obtain approval for a financial transaction request. The FECA 070 can also transmit confirmation information such as a sale, packaging shipping and/or delivery information, or a record or receipt of the completed financial transaction to the fulfillment entity 100 to complete the transaction. The FECA 070 can include a database 071 that can store the account information of the consumer 020.

The payments gateway 080 can provide an interface to and can communicate with a TAAE 090 to facilitate funding for or authorization of a financial transaction request. The TAAE 090 could be a financial institution 091 where the consumer 020 has an assigned and approved transaction account such as a credit card account or a bank account, a prepaid service provider 092, or a goods or service provider 093 where the consumer 020 has an assigned and approved financial account such as a credit or prepaid account. It can be appreciated that the account held by TAAE 090 includes any funding or financial account from which the consumer 020 can control. The TAAE 090 could manage a consumer's bank account, credit card account, prepaid account, brokerage account, insurance account, mobile wallet account, or any credit or debit account. Payments gateway 080 can communicate with the TAAE 090 over a secure system-dependent network 085. In some embodiments, a financial transaction authorization via a TAAE 090 can be completed in near real-time, or with minimal delay such as in the case where the payments gateway is the Automated Clearing House (ACH) and the TAAE 090 is a financial institution 091 housing the funding or financial account. The disclosed system can pre-verify the consumer's 020 identity as the signatory, owner, or controller of the transaction account based on the consumer's mobile device identifier to seamlessly, easily, and automatically facilitate transaction approved by the system.

One purpose of fulfillment entities 100 is to complete (the loop on) the non-financial aspects of the e-commerce transaction processing such as packaging, shipping, delivery, and receipt verification for the contribution, good, and/or service. The fulfillment entity 100 could be a retailer 101, manufacturer Or distributor 102, a creditor 103, a utility company 104, a financial institution 105, a prepaid service provider 106, or a fulfillment house 107. Once the financial transaction has been made and affirmed through the payments gateway 080, the records or database of the fulfillment entity 100 can be updated accordingly. Fulfillment of an e-commerce transaction can vary based on what product or service was acquired, what the specified delivery conditions are, and other parameters as known by or determined by the fulfillment entities 100 such as delivery tracking via the Internet.

It can be appreciated that an advertiser/producer 001 desires to be able to evaluate the effectiveness of their ad campaign. Heretofore, with media outlets 010 such as radio and television, there was no way to accurately determine how many people who were targeted and actually received an advertisement, and how many people who as a result of the ad made an e-commerce transaction or took some other action based on exposure to the advertisement. Likewise, heretofore, it has been difficult if not impossible to accurately measure the effectiveness of loyalty programs, couponing campaigns, and other promotional efforts. Some embodiments of the present disclosure provide an automated system for accurately determining audience behavior or reaction and ultimately providing effectiveness metric back to the advertiser and providing suggestions to the advertiser on how to maximize the return on their ad dollar.

Continuing, FIG. 3 includes an advertiser/producer 001, a production facilitator 002, an ad agency/corporate marketing department 003, a data clearinghouse 004, and an ad campaign effectiveness/measurement module 005. Advertisers often want to target a particular group to achieve a better effectiveness and thus get the most revenue out of their ad expenditure. There are different levels of targeting customers or an audience. For example, an advertiser/producer 001 can choose to target potential customers based on geographic, demographic, and behavior characteristics to name a few, where geographic is a fairly course targeting method and behavioral targeting provides a much finer granularity of targeting. It can be appreciated that often the finer the granularity, the more expensive the cost of the ad per exposure. Behavioral targeting can be performed when the advertiser knows something about the behavior of a potential customer. Such data can be the e-commerce transaction or the consumer's 020 activities related to the advertiser's campaign.

Initially, an advertiser/producer 001 will define the ad campaign, which typically includes budget and target audience, and will often consult an ad agency/corporate marketing department 003 for advice, plan, or campaign to determine how to maximize exposure to targets for a given budget. The advertiser/producer 001 or the ad agency/corporate marketing department 003 will then often hire or consult with a production facilitator 002 (often part of the media outlets 010) to produce the advertisement. After an advertisement is displayed, run, etc., an advertiser/producer 001 wants to get data regarding when and if the advertisement ran and what audience was exposed to the advertisement. Then, this can be compared to the plan to see if the advertiser/producer 001 got the exposure that they paid for.

Adjustments to the cost of the campaign can then be made according to actual exposure results instead of projected results. In some embodiments, a data clearinghouse 004 can monitor multiple communication lines and, for example, can acquire behavioral data based when a consumer 020 such as an audience member performs a transaction based on exposure to an ad from a media outlet 010. Systems such as the FECA 070 and/or the fulfillment entities 100 can also feed transaction data to the data clearinghouse 004.

Although a data clearinghouse 004 is shown at a single location, in some embodiments a data clearinghouse 004 can be ubiquitous and can have and operate in many locations simultaneously where there is data to be mined. The ad campaign effectiveness/measurement module 005 can accept data such as if ads ran as scheduled, or when they ran, how much money was spent on the campaign, or per target, what media or combination of media was used, how many actions, e-commerce transactions, inquires, etc., occurred, what percentage of the audience exhibited what particular responses, etc. Thus, the ad campaign effectiveness/measurement module 005 can set a metric by which all future campaigns can be measured. In some embodiments, the system allows a media outlet 010 to charge a premium price per ad because of the success rate of the advertisement. In some embodiments any of the services providers in the system can set up a pay for performance system where the advertiser/producer 001 only pays for ads that result in an e-commerce transaction.

In accordance with another important aspect of the present invention, after an e-commerce transaction based on an ad/marketing campaign, the advertiser/facilitator 000 can communicate with the consumer 020 using this system. This communication can include any information related to the e-commerce transaction, (i.e., order confirmation, sales receipt, shipping info, addressing into, delivery method, projected delivery date, return info, etc.).

Any or all of the functions of the advertiser/facilitator 000, the act/marketing text campaign application 050, the FECA 070, the payments gateway 080, the TAAE 090, and fulfillment entity 100 may reside on common servers. Logistics is the management of the flow of goods between the point of origin and the point of use in order to meet the requirements of customers or corporations. The fulfillment entity can provide logistics including the integration of information, transportation, inventory, warehousing, material handling and packaging, and security therefore. The fulfillment entity need not be the same entity as the facilitator or producer/provider of the goods or services and can provide a channel of the supply chain that adds the value of time and place utility and can deliver anything from military, commercial, and consumer goods and services.

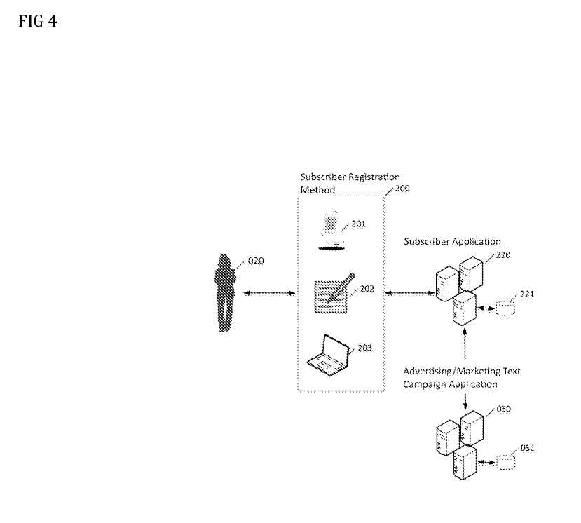

With reference to FIG. 4, subscriber opt-in/registration to a push ad/marketing text campaign in accordance with an embodiment of the present invention includes a subscriber registration method 200, a consumer 020, a subscriber application 220, a database of subscriber data 221, and an ad/marketing text campaign application 050. It can be appreciated that an example is a consumer 020, who is a member of a fan club, registers with the fan club via a subscriber application 220 to receive information and advertisement from the club. The subscriber application 220 and the ad/marketing text campaign application 050 each reside on programmable devices, referred to as servers, which receive input, store and manipulate data, and provide output in a useful format.

Through this method, a consumer 020 may opt-in or register with a subscription application 220 by utilizing a number of different subscriber registration methods 200 such as texting or using a telephone 201, filling out a registration or application form 202, or filling out web-based registration form via a website 203. It will be appreciated by those skilled in the art that filling out a paper registration form or calling a representative may require an additional process to input the information into the subscription application 220.

One purpose of the subscription application 220 is to allow a group of consumers 020 to provide their information such as name, telephone number, postal address, email address, and contact preferences. Example of groups of consumers 020 may include fans or enthusiasts, loyalty program participants, customer bases, and donor bases. The subscriber application is responsible for generating ad/marketing campaign distribution lists for the ad/marketing text campaign application 050. In some embodiments all or part of the data storage and functions of the subscription application 220, the ad/marketing text campaign application 050, and/or any of the functions of the advertiser/facilitator 000 may reside on a common server.

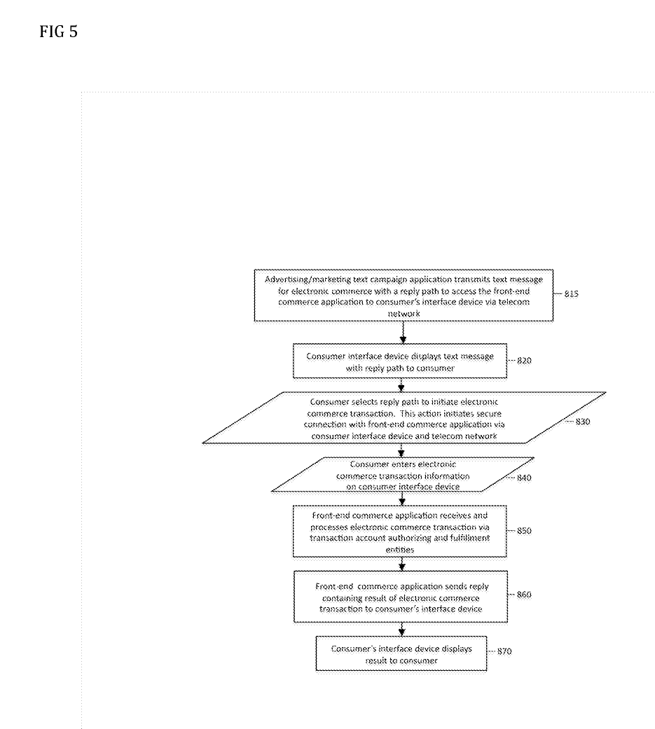

Referring to FIG. 5, a flow diagram illustrating blocks for a push ad/marketing text. campaign message monetization process is disclosed. As illustrated by block 815, the ad/marketing text campaign application 050 transmits text message for e-commerce to the consumer's 020 interface device 030 via the telecommunications network 060. The CID 030 can display the text message to the consumer 020 as illustrated by block 820. In some embodiments, the text message can have an embedded hyperlink that will redirect the consumer 020 to a site and allow the consumer 020 to initiate or complete an e-commerce transaction. The system can contemplate a method with a reference or reply path within the text that the consumer 020 can directly follow or that is followed automatically.

Upon clicking on the reply path in block 830, the consumer 020 initiates a secure connection with the FECA 070 from his/her CID 030 via the telecommunications network 060. At block 840, the consumer 020 is prompted for and enters transaction data such as the number of items, delivery option, delivery address, and various options such as color, size, or date of event, and is prompted for and enters payment information to identify and access a funding or financial account on his/her CID 030. It can be appreciated that payment information to identify, access, and modify or debit a funding or financial account may include, but is not limited to, a user ID, a pass code, a card number, a security code, card verification code, a bank routing number, an account number, an identification name, a password, an access code, a PIN, security questions, or any combination thereof. It can also be appreciated that if the consumer 020 has previously utilized the FECA 070, payment information may already be stored and may not be required to be entered for sequent e-commerce transactions. If the consumer 020 has not utilized the front-end commerce application or desires to use a different funding or financial account than already stored, then payment information must be entered. The system contemplates a method that allows multiple funding or financial accounts to be stored for use for subsequent financial transactions.

As illustrated at block 850, the FECA 070 can receive the e-commerce transaction request from the CID 030. The FECA 070 can then processes e-commerce transaction in a secure environment by interfacing with TAAE 090 and a fulfillment entity 100. As illustrated by block 860, the FECA 070 can send a reply to the CID 030 containing the result of the e-commerce transaction, and the CID 030, as illustrated by block 870, can display the results to the consumer 020. If the FECA 070 determines that request to financial or fulfillment portions of the transaction were not approved, then the FECA 070 can reject the e-commerce transaction request and alert the CID 030, as illustrated per blocks 860 and 870.

The disclosed system can optimize which consumers 020 receive which ads and requests tier replies. Such optimization can be achieved by building profiles of consumer 020 using consumer 020 geographic, demographic, and consumer 020 behavioral information that can be linked to each phone number in the disclosed system. This information can be acquired in near real time from third parties and can be supplemented with the information the disclosed system has acquired.

To determine the consumer's 020 location, the disclosed system can use information provided by the phone or device for TBMS messages. Such location information can be also be acquired from information supplied by the carriers and can work on phones that don't have a global positioning system (GPS).

In some embodiments, a consumer 020 can receive a location-based ad promoting a local merchant. This ad could come, for example, at the bottom of a TBMS message sent by an advertiser. This TBMS ad could then link to a WAP page featuring the company's address, phone number, and other information. The disclosed system could bill for both the initial ad unit (on a CPC basis) and from a secondary action when the consumer 020 reacts to the WAP site.

In some embodiments, consumers 020 can specify if they'd like to receive TBMS-based offers from local or national providers and can specify certain categories that they are interested in receiving information about. The ads can be integrated with TBMS content that a consumer 020 has agreed to, for example, a news feed.

In some embodiments an ad/marketing text campaign application 050 can append contextual ads to user generated text messages. Such appending can be performed based on targeting and profiling as well as the context of the message or multiple messages (i.e., the conversation). Advertisers can pay for each TBMS sent. In some embodiments, mobile operators can make additional revenue when generating a response from the receiver of the ad either based on call back number or when there is a clicking on the URL based on data charges, etc. TBMS advertisements can convey an emotion, a greeting, a romantic phrase, etc., and understanding this “emotion” is part of serving an ad that will promote a positive response.

It can be appreciated that the disclosed system does not require that a consumer 020 be known or identified and have an established user id on file within an information management system as requirement by prior systems. Prior systems allow for texting a link for a website where the communication requires a user name and password for the consumer 020 to navigate through an ordering process. Existing TBMS financial transaction type systems operate in a closed environment where the user of the information management system that is the equivalent to the FECA 070 is required to be known by the CID 030. Thus, existing TBMS based financial transaction systems require an established relationship between the device and a payment system where the disclosed system can accommodate a first time client without requiring registration IDs, etc. The disclosed system provides an open environment, transaction system where the consumer 020 is not required to be known or have an established interface with the FECA 070.

These operations of the closed text to financial transaction systems are substantially identical to the process required to order a good via a website from a personal computer because of the way the FECA 070 and the payment gateway 080 operates. The disclosed system allows a consumer 020 an immediate gateway to buy a product in the moment even when advertisements are broadcast over traditional media outlets such as television and radio.

The disclosed embodiments transmit a very specific invitation to buy based on an advertisement that is sent to a consumer 020. Based on the specific invitation, the system can collect consumer 020 data using an analytics engine that can provide to the retailers competitive location based information, consumer 020 behavior data based on ad, and location based product demand. An analytics engine can operate on data that is captured from responses to invitations to buy including the exposures resulting in financial transactions, etc.

Some providers provide a bug on their website that opens the mobile payment gateway where you have to be a registered customer to access the system that is shown on the website. These systems provide for the financial transaction through in-app ad on websites or smartphones. The disclosed system does not require an application on the phone and in addition, the disclosed system monetizes ad via a TBMS transaction. The disclosed system has the unique ability to monetize a response to an ad in the moment, in real time or in near real time using any consumer 020 device that supports a TBMS system. Systems that require a consumer 020 to register from a personal computer prior to texting to financial transaction have many drawbacks. For one, they are incapable of the monetization of traditional ad. The disclosed system operates without the consumer 020 having to go to a website and establish an account using their computer. The integration with the front-end commerce application into the system provides unique results by providing the capability of providing instant monetization of text messages.

It can be appreciated that information regarding purchasing and delivery of goods and services can include significant confidential data. In some embodiments, CID 030 can send and receive messages using a secure communication or encrypted TBMS message. Such security can be performed by the CID 030 inside or outside of the subscriber identity module (SIM) card. Thus, the encryption may or may not be linked to the SIM.

When a consumer 020 receives an incoming TBMS message with an ad, a verification check can be made to check if the message contains configuration instructions or software to be installed. If not, the TBMS can be processed normally as a conventional TBMS message. If the message has an ad with configuration commands, the CID 030 can evoke encryption checking by looking up user data and if no data can be located the TBMS can be rejected.

For the secure communications, an indicator can be stored in a User Data Header (UDH) and the header can be checked by the gateway to see if the CID 030 can set up some form of secure communications. If no element is detected, the TBMS can be rejected because the TBMS does not conform to the security requirement of having encryption. If an element is found, decryption of the message can be performed using a key stored in a memory of the CID 030. The decryption algorithm described is not detailed as any such known procedures may be applied as far as International Mobile Equipment Identity (IMEI) keys, etc. The decryption result can be parsed to extract the bytes, which can be compared to an IMEI personal number also stored in the memory of mobile medium. A mismatch leads to the TBMS being rejected while a match allows the TBMS to be processed.

To summarize, a security mechanism tor configuring TBMS messages can be achieved through an encryption based on a confidential key. The key can be the IMEI number. The activation of the encryption security requires both parties to agree on its use. The managing party needs to encrypt the message and activate the “Encryption Using IMEI” field in the User Data Header of the TBMS while the user needs to be using a device that is enabled to decrypt a message using the IMEI as the key.

The network node can include a TBMS message encryption detector to detect whether the received TBMS message is encrypted and can include a message encrypted/decrypted for selectively encrypting and decrypting TB MS messages prior to forwarding them to the intended recipient. TBMS messages that are received unencrypted can be encrypted by the TBMS message encrypted/decrypted lithe intended recipient requires encryption and encrypted TBMS messages can be decrypted by the TBMS message encrypted/decrypted if the intended recipient does not support TBMS message encryption. In some embodiments, the sender of a TBMS message may have the option of requiring encryption and TBMS messages received in the network node may, if the intended recipient does not support encryption, forward the TBMS message to a TBMS message holding database. When that occurs, the intended recipient is preferably notified and provided with instructions on how to receive the TBMS message in an alternate manner or using a device that does support encryption.

Each software program described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present invention, represent embodiments of the present invention.

It will be apparent to those skilled in the art having the benefit of this disclosure that the present invention contemplates methods, systems, and media for detecting fraudulent behavior during an e-commerce. (Internet commerce) session. It is understood that the form of the invention shown and described in the detailed description and the drawings are to be taken merely as examples. It is intended that the following claims be interpreted broadly to embrace all the variations of the example embodiments disclosed.

While specific embodiments will be described below with reference to particular configurations of hardware and/or software, those skilled in the art will realize that embodiments of the present invention may advantageously be implemented with other substantially equivalent hardware and/or software systems. Aspects of the invention described herein may be stored or distributed on computer-readable media, including magnetic and optically readable and removable computer disks, as well as distributed electronically over the Internet or over other networks, including telecommunications networks. Data structures and transmission of data (including wireless transmission) particular to aspects of the invention are also encompassed within the scope of the invention.

What is claimed is:

1. A method for electronic commerce comprising;
storing data related to the distribution of advertising content to consumers via at least one media outlet, the content having a message response facilitator useable by a text based message system (TBMS) that can provide a reply path such that a consumer via a consumer interlace device (CID) can respond to an impression created by the advertising content and can request access to a transaction account;
monitoring a response communication from the CID via the reply path; and
facilitating transmission of a selectable link to the CID, the selectable link when activated places the CID in communication with a payment gateway and the transaction account via an Internet Protocol format, the CID responds to the front-end commerce application (FECA) and receives request for information related to advertisement and the transaction account, replies to the request and receives a status message from a transaction account.

2. The method of claim 1, wherein the communication occurs without downloading a financial transaction application and executing the financial transaction application on the CID.

3. The method of claim 1, further comprising automatically placing the CID in communication with the transaction account via a payments gateway.

4. The method of claim 1, further comprising automatically placing the CID in an Internet Protocol based communication with a front-end commerce application, a payment gateway, and a transaction account authorization entity to access the transaction account.

5. The method of claim 1, further comprising relating the advertising content to and the at least one advertising outlet and at least one user response.

6. The method of claim 1, further comprising monitoring and storing data related to consumer activity associated with the advertising content.

7. The method of claim 6, further comprising generating metadata from the stored data to provide data related to consumer activities based on ads.

8. The method of claim 1, wherein the message response facilitator is a specific message response code unique to one of a specific advertising campaign or a specific media outlet.

9. The method of claim 1 further comprising notifying a fulfillment entity in response to the monitoring.

10. The method of claim 1 wherein the TBMS is a simple message response system (SMRS).

11. The method of claim 1 wherein the media outlet comprises one of a television, a networked computer, signage, printed material, a radio broadcast, a wireless mobile communication device, or an advocate.

12. A computer-usable medium for conducting a transaction, said computer-usable medium embodying computer program code, said computer program code comprising computer executable instructions configured to:
storing data related to a distribution of advertising content via at least one media outlet, the content having a selectable link communicable via a text based message system (TBMS);
monitoring a response communication from the interface device via the reply path;
providing a reply path for the selectable link such that the CID can communicate in response to an impression created by the advertising content and request a link to a transaction account; and
facilitating the transmitting of a link to the CID, the link when activated places the CID in communication with a transaction account via a payment gateway, the communication includes a request for information related to the transaction account, a reply to the request, and an authorization message from a transaction account authorization entity.

13. The computer-usable medium of claim 12, wherein said computer program code further comprises computer executable instructions configured such that a browser is activated not specific to one of a payment gateway and a transaction account authorization entity.

14. The computer-usable medium of claim 12, wherein said computer program code further comprises computer executable instructions when executed relate the advertising content and at least one advertising outlet with at least one user response.

15. The computer-usable medium of claim 12, wherein said computer program code further comprises computer executable instructions when executed to monitor and store data related to activity associated with the advertising content and the operation of the CID.

16. The computer-usable medium of claim 12, wherein said computer program code further comprises computer executable instructions that when executed generates metadata from CID activity data and ad campaign data to predict consumer behaviors based on data related to future ad campaigns.

17. A method for facilitating e-commerce comprising:
storing data related to an advertisement from an advertising campaign, the advertisement having content, and the campaign to include at least one media outlet associated with a message response facilitator;
providing, via a text based system, the selectable response link to at least one consumer interface device (CID), such that a consumer can respond to the advertising content via a response link associated with the message response facilitator, the response link having at least one response path usable to place the CID in communication with a transaction account;
querying the CID and receiving data related to the selection of the response link, the response communication to include a request for an association with a transaction account; and,
placing the communication with a payment gateway, the communication to include a request for information related to the transaction account, a reply to the request, and an authorization message from a transaction account authorization entity.

18. The method of claim 17, further comprising transmitting data to a fulfillment entity in response to a transaction account change request.

19. The method of claim 17, further comprising acquiring, storing, and compiling activity data associated with responses to the advertising content.

20. The method of claim 17, further comprising storing data related to logistical aspects of the transaction.
